(19) United States
(12) Patent Application Publication
(10) Pub. No.: US 2006/0023921 A1
(43) Pub. Date: Feb. 2, 2006

(54) Authentication apparatus, verification method and verification apparatus

(75) Inventors: Hirofumi Saitoh, Ogaki-city (JP); Keisuke Watanabe, Mizuho-city (JP)

Correspondence Address: MCDERMOTT WILL & EMERY LLP, 600 13TH STREET, N.W., WASHINGTON, DC, 20005-3096, US

(73) Assignee: Sanyo Electric Co., Ltd.

(21) Appl. No.: 11/188,757

(22) Filed: Jul. 26, 2005

(30) Foreign Application Priority Data
Jul. 27, 2004 (JP) 2004-218942
Nov. 2, 2004 (JP) 2004-318846

(51) Int. Cl. G06K 9/00

(52) U.S. Cl. 382/115

(57) ABSTRACT

An input unit inputs respectively a plurality of partial images corresponding to a user to be authenticated. An extraction unit extracts feature points of a fingerprint respectively from the plurality of partial images inputted. A generation unit synthesizes the feature points extracted respectively from the plurality of partial images and then generates feature point information for authentication. An acquisition unit acquires reference feature point information. A rotation unit performs phase rotation on the generated authentication feature point information so that a directional component, namely, a phase component, contained in the generated authentication feature point information approaches that contained in the acquired reference feature point information. An authentication unit authenticates the authentication feature point information whose phase has been rotated, based on the reference feature point information.

### BACKGROUND OF THE INVENTION

1. Field of the Invention

The present invention relates to apparatus for carrying out the authentication using the biological information, and relates also to verification method and verification apparatus used in the event of carrying out the authentication.

2. Description of the Related Art

In recent years, much attention has been focused on biometric authentication, which uses such biological information as fingerprint, palm print, face image, iris image or voiceprint in substitution for a password and the like for user identification. In such biometric authentication, a fingerprint or the like belonging to a user is enrolled in advance, and the fingerprint of said user requesting identity authentication is compared with the previously enrolled fingerprint so as to carry out authentication. Biometric authentication like this can provide higher security than password authentication, but the problem is its requirement for a larger sensor that can recognize fingerprints. Yet, if the capacity of biometric authentication is added to mobile phones or PDAs (personal digital assistants), then it will offer the advantage of enhanced security for such portable devices, which are often carried around by the users. However, since mobile phones and PDAs are small in size, the sensor, which will go into them, must be small in size, too. In this regard, there is a proposed technology in which a fingerprint image of a part of a fingerprint is acquired by a sensor, then a plurality of fingerprint images are obtained by shifting the fingerprint, and finally the plurality of fingerprint images are synthesized to obtain a fingerprint image for the whole fingerprint (See Japanese Patent Application Laid-Open No. 2003-248828, for instance).

In the authentication based on fingerprint images, feature points of a fingerprint image are extracted. Extraction of feature points from a fingerprint image of a part of a fingerprint is done without recognizing the form of the whole fingerprint. In this case, the extraction accuracy of feature points is generally lower than when feature points are extracted from a fingerprint image of a whole fingerprint. This results in a greater error of the extracted feature points in relation to the real ones. Moreover, if the acquired fingerprint image is slanting off from the fingerprint image for comparison, the captured fingerprint must be rotated, but this rotation can further increase the error of the extracted feature points. Thus, if the tolerance in the authentication using the feature points of partial fingerprint image is the same as that in the authentication using the feature points of whole fingerprint image, then the identification reject rate (false nonmatch rate), which is the probability of rejecting a valid individual, will rise. The identification reject rate may be lowered by loosely setting the tolerance. But such loose setting may raise the false identification rate (false match rate), which is the probability of falsely authenticating individuals other than the intended one.

### SUMMARY OF THE INVENTION

The present invention has been made in view of the foregoing circumstances and problems, and an object thereof is to provide an authentication apparatus with improved identification accuracy when authentication is to be carried out using feature points extracted from an image of a part of a fingerprint.

In order to solve the above problems, an authentication apparatus according to a preferred mode of carrying out the present invention comprises: an input unit which inputs a plurality of pieces of partial information corresponding to parts of biological information on an authenticatee; an extraction unit which extracts feature points of the biological information respectively from the plurality of pieces of partial information inputted to the input unit; a generation unit which synthesizes the feature points extracted respectively from the plurality of pieces of partial information and which generates feature point information for authentication; an acquisition unit which acquires reference feature point information to be compared with the authentication feature point information generated by the generation unit; a rotation unit which performs phase rotation on the generated authentication feature point information so that a phase component contained in the generated authentication feature point information approaches that contained in the acquired reference feature point information; and an authentication unit which authenticates the authentication feature point information to which the phase rotation has been performed by the rotation unit, based on the acquired reference feature point information. The authentication unit adjusts tolerance for authentication in accordance with a degree of phase rotation performed by the rotation unit.

According to this mode of carrying out the present invention, the error contained in the feature points extracted from the partial information varies according to the phase rotation and therefore the tolerance is adjusted in accordance with a degree of phase rotation of the feature points extracted from the partial information. As a result thereof, the authentication can be carried out with the high level of accuracy, required for authentication, suitable for the degree of phase rotation.

If the degree of rotation performed by the rotation unit increases, the authentication unit may increase the tolerance. If the degree of rotation is small, the tolerance will be small, so that the level of precision with which the authentication is performed is raised. On the other hand, if the degree of rotation is large, the tolerance will be large. In either case, the false nonmatch rate, which is the probability of rejecting a valid individual, can be lowered.

The authentication unit may perform authentication by comparing an error between a line segment between the feature points obtained from the authentication feature point information to which the phase rotation has been performed and a line segment between the feature points obtained from the acquired reference feature point information with the tolerance, and may increase the tolerance if the line segment between the feature points obtained from the authentication feature point information to which the phase rotation has been performed crosses a plurality of pieces of partial information. The reference feature point information acquired by the acquisition unit is generated from a plurality of pieces of partial information in a similar manner to the authentication feature point information, and at the time of authentication the authentication unit may increase the tolerance if the line segment between the feature points obtained from the acquired reference feature point information crosses a plurality of pieces of partial information. If the line segment between the feature points crosses a plurality of pieces of partial information, there is a possibility that the error is rather large. In such a case, the tolerance is increased accordingly, so that the false nonmatch rate, which is the probability of rejecting a valid individual, can be lowered.

Another preferred mode of carrying out the present invention relates also to an authentication apparatus. This apparatus comprises: an input unit which inputs a plurality of pieces of partial information corresponding to parts of biological information on an authenticatee; and a display unit which generates feature point information for authentication by synthesizing feature points after the feature points have been extracted respectively from the inputted plurality of pieces of partial information, performs phase rotation on the generated authentication feature point information so that a phase component contained in the generated authentication feature point information approaches that contained in reference feature point information for comparison, and which displays a result of authenticating the authentication feature point information to which the phase rotation has been performed, based on the reference feature point information based on tolerance adjusted in accordance with an amount of the phase rotation and the reference feature point information.

According to this mode of carrying out the present invention, the result of authentication is displayed. Thus, the displaying of the result of authentication can have the user recognize the result of authentication. And even when the authentication has ended in a failure, the user can be informed of the next processing to be operated.

Still another preferred mode of carrying out the present invention relates to a verification method. This method comprises: dividing a reference image for verification into predetermined regions; calculating a predetermined directional component as a characteristic quantity for each of the regions; and recording the directional component. The “predetermined region” may be a linear region. This linear region may be a linear or nonlinear region. The “predetermined directional component” may be a value calculated based on a gradient vector of each pixel. According to this mode of carrying out the present invention, the reference data for verification can be enrolled with a small memory capacity.

This verification method may further comprise: dividing an image to be verified into predetermined regions; calculating a predetermined directional component as a characteristic quantity for each of the regions; and verifying the calculated directional component with the directional component of the reference image. According to this mode of carrying out the present invention, the predetermined directional components are verified against each other, so that the verification can be carried out with smaller memory capacity and smaller calculation amount.

Still another preferred mode of carrying out the present invention relates also to a verification method. This method comprises: dividing a reference image for verification into predetermined regions; calculating a single physical quantity as a characteristic quantity for each of the regions; and recording the single physical quantity. The “single physical quantity” may be a vector quantity or scalar quantity, and it may be the count of switching of stripes, for instance. According to this mode of carrying out the present invention, the reference data for verification can be enrolled with a small memory capacity.

This verification method may further comprise: dividing an image to be verified into predetermined regions; calculating a single physical quantity as a characteristic quantity for each of the regions; and verifying the calculated single physical quantity with the single physical quantity of the reference image. According to this mode of carrying out the present invention, one single physical quantity is verified against another single physical quantity, so that the verification can be carried out with smaller memory capacity and smaller calculation amount.

Still another preferred mode of carrying out the present invention relates also to a verification method. This method comprises: dividing a reference image for verification into linear regions; calculating a value obtained based on a direction of ridge or furrow line as a characteristic quantity for each of the regions; and recording the value. According to this mode of carrying out the present invention, the reference data for verification can be enrolled with a small memory capacity.

This verification method may further comprise: dividing an image to be verified into linear regions; calculating a value obtained based on a direction of ridge or furrow line as a characteristic quantity for each of the regions; and verifying the calculated value obtained based on the direction of ridge or furrow line with the value, obtained based on the direction of ridge or furrow line, of the reference image. According to this mode of carrying out the present invention, the values obtained based on the direction of ridge or furrow line are verified against one another, so that the verification can be carried out with smaller memory capacity and smaller calculation amount.

This verification method may further comprise: setting one or a plurality of coordinate axes in at least one of the reference image for verification and the image to be verified, wherein the value may be obtained for the respective coordinate axes. The verifying may be such that the above values obtained for their respective coordinate axes are verified against one another. According to this mode of carrying out the present invention, both the request for small memory capacity and calculation amount and the request for the high level of authentication accuracy can be satisfied.

The calculating may undergo an averaging process for each of the regions. For example, the characteristic quantities of each pixel that constitutes the “region” may be averaged. According to this mode of carrying out the present invention, the noise can be reduced as a result of the averaging process. The amount of data can also be reduced.

Still another preferred mode of carrying out the present invention relates also to a verification method. This method comprises: slicing a reference image for verification so as to be divided into linear regions; calculating a count of image density switching as a characteristic quantity for each of the linear regions; and recording the count of image density switching. The “count of image density switching” may be the count of switching between black and white in the case of binary image data. According to this mode of carrying out the present invention, the reference data for verification can be enrolled using a small memory capacity.

This verification method may further comprise: slicing an image to be verified so as to be divided into linear regions; counting the number of image density switchings as a characteristic quantity for each of the linear regions; and verifying the counted number of image density switchings with the count of image density switching in the reference image. According to this mode of carrying out the present invention, the counts of image density switching are verified against one another, so that the verification can be carried out with smaller memory capacity and smaller calculation amount.

Still another preferred mode of carrying out the present invention relates to a verification apparatus. This apparatus comprises: an image pickup unit which captures an image to be verified; a calculation unit which divides the captured verification image into predetermined regions and calculates a predetermined directional component as a characteristic quantity for each of the regions; and a verification unit which verifies the directional component of the verification image with a directional component of a reference image. The apparatus may further comprise a recording unit which records a “directional component of the reference image”. According to this mode of carrying out the present invention, the directional components are verified against one another, so that the verification can be carried out with smaller memory capacity and smaller calculation amount.

Still another preferred mode of carrying out the present invention relates also to a verification apparatus, comprising: an image pickup unit which captures an image to be verified; a calculation unit which divides the captured verification image into predetermined regions and calculates a single physical quantity as a characteristic quantity for each of the regions; and a verification unit which verifies the single physical quantity of the verification image with a single physical quantity of a reference image. The apparatus may further comprise a recording unit which records a “single physical quantity of the verification image”. According to this mode of carrying out the present invention, one single physical quantity is verified against another single physical, so that the verification can be carried out with smaller memory capacity and smaller calculation amount.

The calculation unit may carry out an averaging process for each of the regions. According to this mode of carrying out the present invention, the noise can be reduced as a result of the averaging process. The amount of data can also be reduced.

It is to be noted that any arbitrary combination of the above-described structural components as well as the expressions according to the present invention changed among a method, an apparatus, a system, a computer program, a recording medium and so forth are all effective as and encompassed by the present embodiments.

### BRIEF DESCRIPTION OF THE DRAWINGS

FIG. 1 illustrates a structure of an authentication apparatus according to a first embodiment of the present invention.

FIG. 2 illustrates a structure of an authentication unit shown in FIG. 1.

FIG. 3 illustrates an outline of identity verification by the authentication apparatus of FIG. 1.

FIGS. 4A to 4D illustrate an outline of processing by a decision unit shown in FIG. 2.

FIGS. 5A and 5B show examples of display contents to be given by an authentication result display unit shown in FIG. 1.

FIG. 6 is a flowchart showing a fingerprint authentication procedure by the authentication apparatus of FIG. 1.

FIG. 7 is a function block of a verification apparatus according to a second embodiment of the present invention.

FIG. 8 is a flowchart showing a processing for generating reference data in a verification apparatus according to the second embodiment.

FIG. 9 shows a fingerprint image captured in the second embodiment.

FIG. 10 illustrates a vector V(y0) that represents a feature in a linear region of FIG. 9.

FIG. 11 shows a distribution of characteristic quantities obtained when the image of FIG. 9 is sliced for each linear region.

FIG. 12 is a flowchart showing an authentication processing of a verification apparatus according to the second embodiment of the present invention.

FIG. 13 shows how the distribution of characteristic quantities of reference data are superimposed on that of data to be authenticated in the second embodiment.

FIG. 14 illustrates an example in which an image is sliced perpendicularly according to a third embodiment of the present invention.

FIG. 15 illustrates a distribution of characteristic quantities in their respective linear regions shown in FIG. 14.

FIG. 16 illustrates an example of an image sliced in the direction of 45 degrees according to the third embodiment.

FIG. 17 illustrates a distribution of characteristic quantities in their respective linear regions shown in FIG. 16.

FIG. 18 illustrates an example in which the iris part of an eye is divided into concentric areas according to a fourth embodiment of the present invention.

FIG. 19 illustrates a distribution of characteristic quantities in their respective concentric areas shown in FIG. 18.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

### First Embodiment

Before describing the present invention in detail, the outline of the present invention will be described first. A first embodiment of the present invention relates to an authentication apparatus that carries out authentication based on partial fingerprint images (hereinafter referred to as “partial images”) obtained from the fingerprint of a user to be authenticated (hereinafter, “user to be authenticated” will be referred to as “user to be verified” or “authenticatee” also). The authentication apparatus acquires a plurality of partial images from a user to be identified and handles the plurality of partial images such that they, in combination, correspond to the fingerprint of the user. The authentication apparatus according to the first embodiment generates feature point information for authentication (hereinafter also referred to as “authentication feature point information”) by first extracting feature points from each of partial images and then synthesizing the feature points extracted therefrom in such a manner as to correspond to the whole fingerprint of the user. It is assumed here that the authentication apparatus stores feature point information for reference (hereinafter also referred to as “reference-feature point information”) in advance, which is to be compared with the authentication feature point information. The authentication feature point information may sometimes be such that the phase thereof is shifted from the reference feature point information. For example, a fingerprint corresponding to authentication feature point information may be at a slant from the fingerprint corresponding to the reference feature point information. Since a shift of phase like this leads to a drop in verification accuracy, the phase of the authentication feature point information shall be rotated to approach the phase of the reference feature point information.

The authentication apparatus performs authentication of authentication feature point information by comparing a line segment between a feature point contained in the authentication feature point information with that contained in the reference feature point information. It is to be noted that since the authentication apparatus extracts feature points from each of partial images in generating authentication feature point information, there may be cases where the extracted feature points are deviated from the actual feature points. If the feature points involving errors like this are phase-rotated, the errors would further increase. In such a case, the success rate of authenticating the authentication feature point information may drop unless the tolerance, or permissible amount, for authentication is slacked or enlarged to a certain degree. On the other hand, the permissible amount for authentication enlarged to a certain degree may result in increased frequency of false verification of authentication feature point information that must not be authenticated. The authentication apparatus according to the first embodiment adjusts the tolerance or permissible amount according to the magnitude of rotated phase of authentication feature point information. That is, for a greater degree of rotation of feature points for authentication, it is assumed that there will be more error, so that the permissible amount is increased. On the other hand, for a smaller degree of rotation of feature points for authentication, it is assumed that there will be less error, so that the permissible amount is decreased.

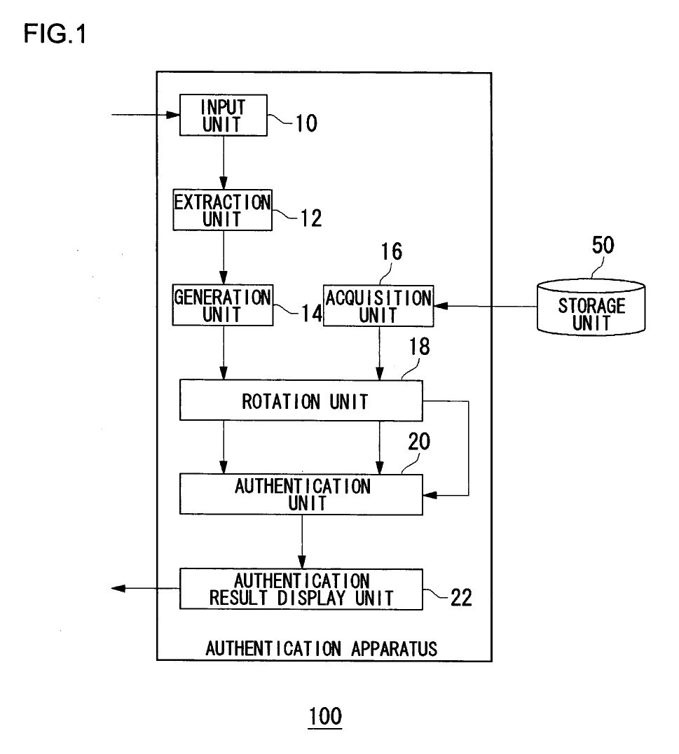

FIG. 1 illustrates a structure of an authentication apparatus 100 according to the first embodiment of the present invention. The authentication apparatus 100 includes an input unit 10, an extraction unit 12, a generation unit 14, an acquisition unit 16, a rotation unit 18, an authentication unit 20 and an authentication result display unit 22, and is also provided with a storage unit 50.

The input unit 10 inputs each of a plurality of partial images belonging to a user to be authenticated. As described, the partial images are the user's biological information, or fingerprint image here, divided into a plurality of images. The fingerprint image is an image of a fingerprint digitized by a scanner or the like. It is also to be noted that the partial images may show the user's fingerprint oriented in an arbitrary direction. For instance, they may be slanted.

The extraction unit 12 extracts feature points of a fingerprint from each of the plurality of partial images inputted. The features of a fingerprint, which include the edge lines outlining fingerprint ridges, the part of ridge edge lines where the tangential direction changes abruptly, and the terminations and bifurcations of ridge edge lines, may be any of these or may include other feature points as well. For example, although an edge line is a feature but not exactly a feature point, the feature points should be understood to include the edge lines. The method for extracting these feature points may be any conventional method, and therefore the description thereof is omitted. Here, feature points are extracted from each of partial images.

The generation unit 14 generates authentication feature point information by synthesizing the feature points extracted from each of a plurality of partial information in such a manner that the feature points are correlated with one another. Accordingly, the feature point information for authentication has such a structure that the feature points are each associated with their coordinates and directional components. For example, a feature point may be expressed as (x1, y1, φ1).

The storage unit 50 stores reference feature information, with which feature point information for authentication is compared to authenticate the user. The reference feature point information has the same content structure as the authentication feature point information. It is to be noted here that the reference feature point information, which is to be stored before any authentication processing, may be structured based either on the feature points extracted from a plurality of partial images as with the authentication feature point information or on the feature points extracted from a fingerprint image for a whole fingerprint. The acquisition unit 16 acquires reference feature point information from the storage unit 50 at the time of authentication.

The rotation unit 18 performs phase rotation on the generated authentication feature point information so that the direction components, or the phase components, contained in the generated authentication feature point information approach those contained in the acquired reference feature point information. Here, a histogram corresponding to the phase components is generated from the generated reference feature point information, and also a histogram corresponding to the phase components is generated from the acquired reference feature point information. The latter may be generated in advance. Furthermore, the phases corresponding to the peaks of the two histograms are identified, and the difference between those phases is determined to be the phase rotation amount. According to this phase rotation amount, the rotation unit 18 rotates the phase components of the authentication feature point information. The rotation unit 18 outputs the reference feature point information, the authentication feature point information after the phase rotation and the amount of phase rotation to the authentication unit 20.

The authentication unit 20 verifies the authentication feature point information after phase rotation by checking it against the reference feature point information. The authentication unit 20 extracts line segments between feature points that can be obtained from the authentication feature point information after phase rotation (hereinafter referred to as “line segments for authentication” or “authentication line segments”). The line segments for authentication may be line segments between either all the feature points or a predetermined number of feature points. Furthermore, the authentication unit 20 extracts line segments between feature points from the reference feature point information (hereinafter referred to as “line segments for reference” or “reference line segments”) in the same manner as from the authentication feature point information after phase rotation. The authentication unit 20 compares the length of a line segment for authentication with that of the corresponding line segment for reference and decides on a match between the two if the difference is smaller than a predetermined permissible amount. By doing this processing for all the line segments for authentication and the corresponding line segments for reference, the authentication unit 20 calculates the similarity of the authentication feature point information to the reference feature point information. When the similarity is significant, the authentication unit 20 determines a success of authentication of the authentication feature point information after phase rotation.

In this processing as described above, the authentication unit 20 adjusts the tolerance for authentication in response to the degree of phase rotation given by the rotation unit 18. That is, the tolerance will be increased if the degree of phase rotation given by the rotation unit 18 is increased. For example, if the amount of rotation is θ, then the tolerance is changed in proportion to θ. When θ is between π and 2π, the tolerance is changed in proportion to the absolute value of the remainder of θ minus 2π. Furthermore, the tolerance may be increased when a line segment for authentication crosses a plurality of partial images. Also, when the reference feature point information is generated from a plurality of partial images as with the authentication feature point information, the tolerance may be increased when a line segment for reference crosses a plurality of partial images. The authentication result display unit 22 displays the result of authentication by the authentication unit 20, namely, the result of authentication obtained by comparing the authentication feature point information after phase rotation with the reference feature point information. The authentication result display unit 22 may also display the authentication feature point information.

In terms of hardware, such a structure as above can be realized by a CPU, a memory and other LSIs of an arbitrary computer. In terms of software, it can be realized by memory-loaded programs or the like, but drawn and described herein are function blocks that are realized in cooperation with those. Thus, it is understood by those skilled in the art that these function blocks can be realized in a variety of forms such as by hardware only, software only or the combination thereof.

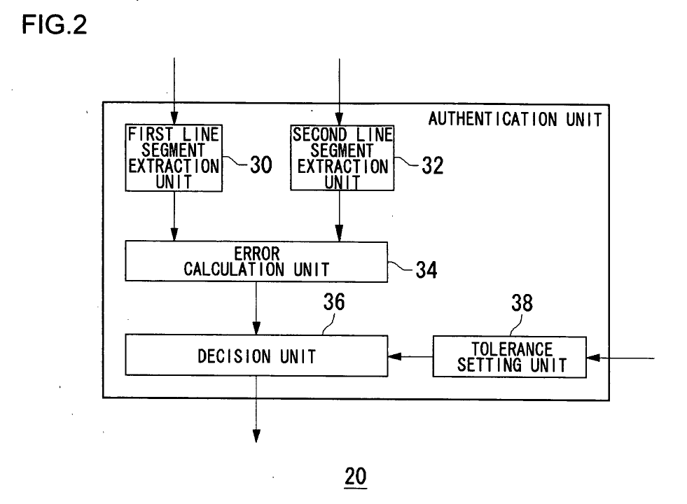

FIG. 2 illustrates a structure of an authentication unit 20. The authentication unit 20 includes a first line segment extraction unit 30, a second line segment extraction unit 32, an error calculation unit 34, a decision unit 36 and a tolerance setting unit 38.

The first line segment extraction unit 30 receives an input of authentication feature point information after phase rotation and extracts line segments for authentication therefrom. The second line segment extraction unit 32 receives an input of reference feature point information and extracts line segments for reference therefrom. It is to be appreciated that line segments for reference may be extracted in advance and included in the reference feature point information.

The error calculation unit 34 calculates the error of one of the authentication line segments from the corresponding one of the reference line segments. For example, if the length of an authentication line segment is denoted by d1 and that of a reference line segment by d2, the error will be given by the absolute value of d1−d2.

The tolerance setting unit 38 adjusts the tolerance in response to the amount of rotation. As described, the tolerance is adjusted such that the greater the amount of rotation, the larger the tolerance is. When an authentication line segment or reference line segment crosses a plurality of partial images, the tolerance may be so adjusted to be larger. In such a case, the information indicating the fact is inputted via a signal line (not shown).

The decision unit 36 decides on a match between an authentication line segment and a reference line segment if the error calculated by the error calculation unit 34 is smaller than a tolerance, or on a nonmatch between them if the error is larger than the tolerance. The decision unit 36 further carries out the above processing on all the authentication line segments and reference line segments and adds the degree of similarity according to the match or nonmatch. For example, a predetermined value is added for the match, and no predetermined value is added for the nonmatch, and the results are all added up for all the line segments to derive the degree of similarity. The decision unit 36 finally compares the thus derived degree of similarity with a threshold value and determines a success of authentication if the degree of similarity is greater than the threshold value.

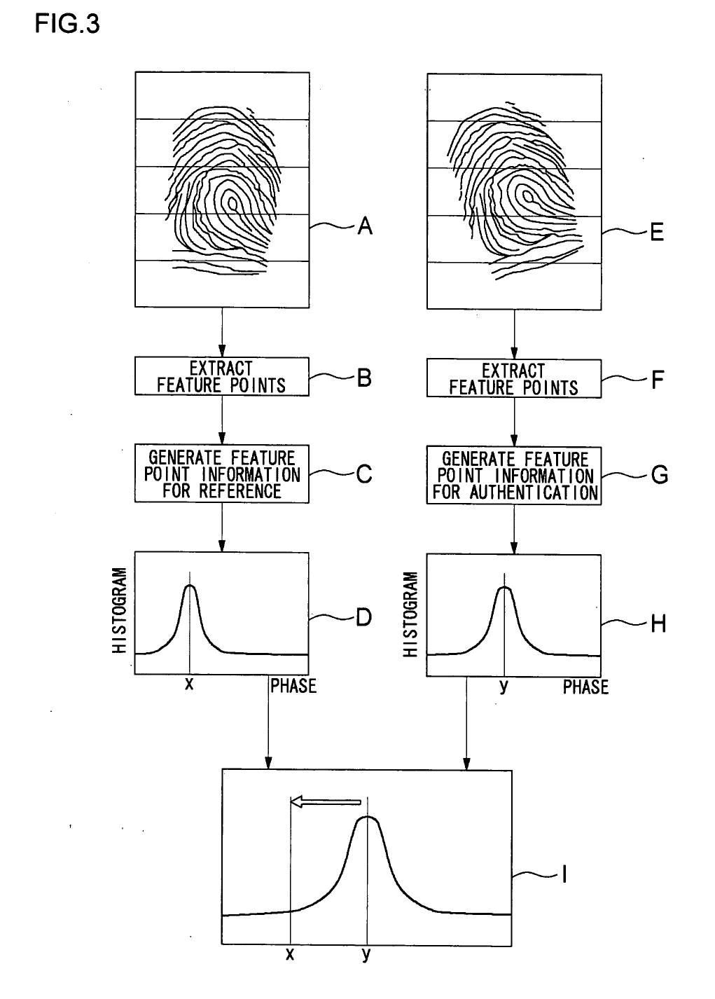

FIG. 3 illustrates an outline of identity verification by an authentication apparatus 100. Block A of FIG. 3 shows a fingerprint image to be used as reference. Five partial images are defined by dividing the whole area into five parts. In Block B of FIG. 3, feature points are extracted from the fingerprint image of Block A. As mentioned above, the feature points may be extracted from either a fingerprint image or partial images. In Block C of FIG. 3, feature point information for reference is generated from the extracted feature points. Block D of FIG. 3 shows a histogram for phase, which has been generated from the reference feature point information. As shown in Bock D, the peak of the histogram corresponds to phase x. It is to be noted that the processing of Block A through Block D may be carried out in advance of any verification processing.

Block E of FIG. 3 shows a fingerprint image to be used for verification. In the same way as in Block A, five partial images are defined, and they are inputted to an input unit 10 as shown in FIG. 1. Here, a plurality of partial images are so arranged as to clarify their mutual relationship, but they may come otherwise. As shown, the fingerprint of Block E is slanting off from the one shown in Block A. Block F and Block G are the processings corresponding to those at the extraction unit 12 and the generation unit 14 of FIG. 1, respectively. Block H shows a histogram for phase, which has been generated from the authentication feature point information. As shown in Block H, the peak of the histogram corresponds to phase y.

Block I of FIG. 3 illustrates the processing at the rotation unit 18 of FIG. 1, in which the peak phase y of the histogram corresponding to the authentication feature point information is shifted to the peak phase x of the histogram corresponding to the reference feature point information. This processing is equivalent to a rotation which brings the phase of the fingerprint image of Block E close to the phase of the fingerprint image of Block A. It is to be noted that the rotation like this means a similar rotation for the boundaries of partial images of Block E.

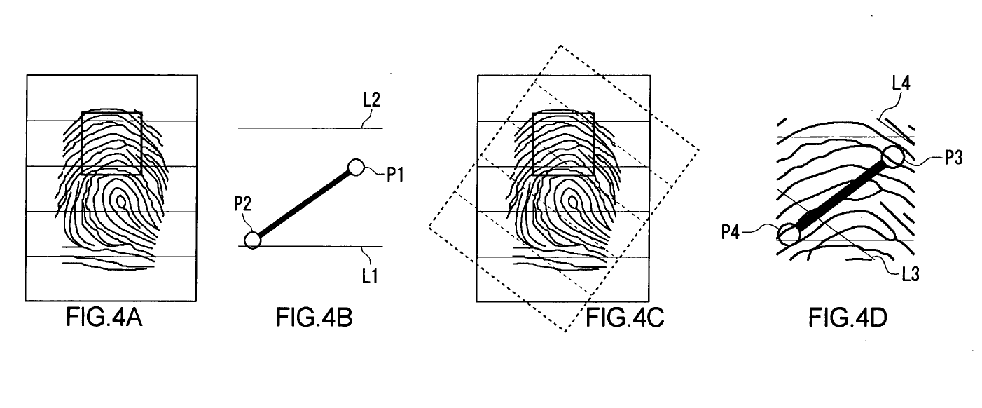

FIGS. 4A to 4D illustrate the outline of processing by a decision unit 36. FIG. 4A, which corresponds to Block A, shows a fingerprint image to be used as reference. FIG. 4B shows two feature points P1 and P2 and a reference line segment connecting them, which are both within the part delineated by a square. The boundaries of the partial region are shown as L1 and L2 in FIG. 4B. In other words, the reference line segment is within one partial image. FIG. 4C illustrates a fingerprint image to be used for authentication. The dotted lines correspond to the solid lines in Block E, and, as shown in FIG. 4C, the fingerprint image has been rotated by the rotation unit 18 of FIG. 1 to face the same direction as FIG. 4A. For convenience, the boundaries of partial regions in FIG. 4A are shown in solid lines. FIG. 4D shows two feature points P3 and P4 and a authentication line segment connecting them, which are both within the part delineated by a square in FIG. 4C. The boundaries of the partial region are shown as L3 and L4 in FIG. 4D. The authentication line segment is contained in two partial images.

It is assumed here that P3 corresponds to P1, and P4 to P2. P1 and P2 are extracted from one fingerprint image or one partial image. On the other hand, P3 and P4 are extracted from two separate partial images. As a result, there may be a difference in the accuracy of feature extraction between the two, and there may be cases where the positions of P3 and P4 are deviated from those of P1 and P2, respectively. The position errors of P3 and P4 in relation to P1 and P2 may be further increased by the error involved in the rotation of feature point information for authentication, which is the error in the amount of phase rotation as determined in Block I. In such a case, the authentication apparatus 100 uses a larger tolerance.

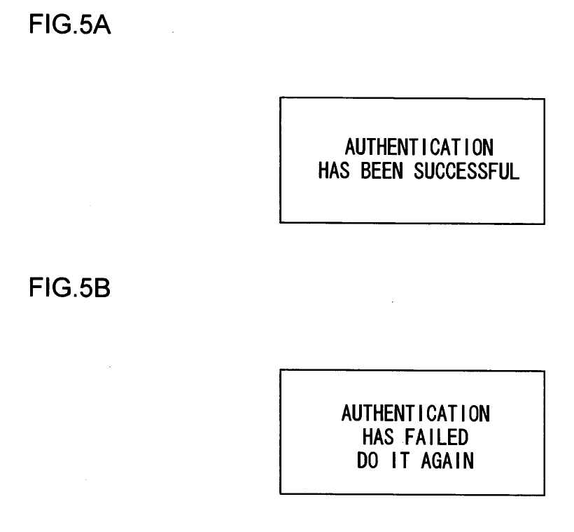

FIGS. 5A and 5B show examples of display messages to be given by the authentication result display unit 22. FIG. 5A shows a message displayed when authentication has been successful, and FIG. 5B when authentication has been unsuccessful. The authentication result display unit 22 may not only display the authentication results but also the authentication feature point information such as coordinates of the feature points. When the coordinates of the feature points are displayed, the fingerprint image may be additionally displayed. Thereby, the user can be aware of how his/her fingerprint has been processed. It is to be noted here that the authentication result display unit 22 may not only give such messages on a display or the like but also convey the displayed contents to a PC (personal computer) or the like via a network (not shown).

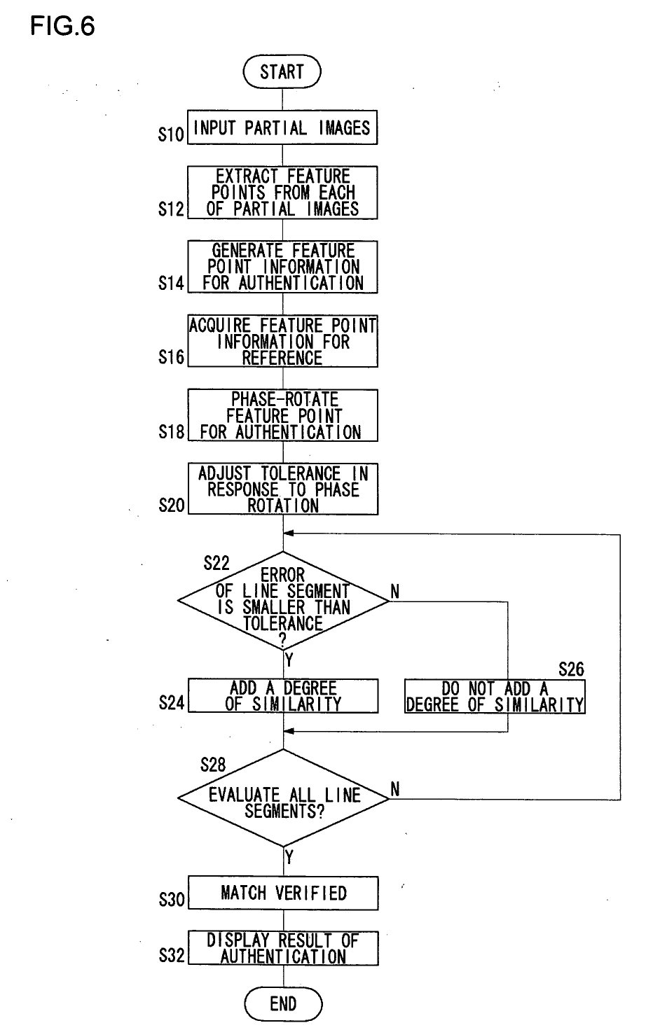

A fingerprint authentication procedure by an authentication apparatus 100 implementing the above structure will be described hereinbelow. FIG. 6 is a flowchart showing a fingerprint authentication procedure by the authentication apparatus 100. The input unit 10 inputs partial images (S10). The extraction unit 12 extracts feature points from each of the partial images (S12). The generation unit 14 generates feature point information for authentication (S14). The acquisition unit 16 acquires feature point information for reference from the storage unit 50 (S16). The rotation unit 18 phase-rotates the authentication feature point information so that it approximates the phase contained in the reference feature point information for reference (S18).

The authentication unit 20 adjusts tolerance in response to the amount of phase rotation (S20). If the error of the line segment is smaller than the tolerance (Y of S22), the authentication unit 20 adds a degree of similarity (S24). On the other hand, if the error of the line segment is not smaller than the tolerance (N of S22), the authentication unit 20 does not add a degree of similarity (S26). At this point, if the evaluation as above has not been done on all the line segments (N of S28), the processing from Step S22 onward is repeated. If the evaluation as above has been done on all the line segments (Y of S28), a decision is made on the match between the authentication feature point information and the reference feature point information by comparing the combined similarity with the threshold value (S30). The authentication result display unit 22 displays the result of authentication (S32).

In the authentication apparatus 100, the input unit 10 inputs partial images. Reduction of memory is a reason for inputting partial images instead of a fingerprint image representing a whole fingerprint. Hereinbelow, the effect of such an arrangement is explained together with concrete numerical values. When a fingerprint image is a gray-scale image of 8 bits per pixel, on a screen of 256 pixels both vertically and horizontally, one screen will be composed of 64 KB (kilobytes). On the other hand, if a partial image, which is ¼ of a fingerprint image, is used, the required memory size will also be ¼, and one screen will be composed of 16 KB. When a fingerprint image is one bit per pixel, on a screen of 256 pixels both vertically and horizontally, one screen will consist of 8 KB. In this case, if a partial image, which is ¼ of a fingerprint image, is used, the required memory size will be 2 KB.

If the input unit 10 inputs a fingerprint image representing a whole fingerprint, instead of partial images, for identification, then the authentication apparatus 100 would be required to have a memory capable of storing fingerprint data for two screens. However, if the input unit 10 inputs partial images as in the first embodiment, the memory size can be reduced according to the size of a partial image. That is, if the size of a partial image is ½ of a fingerprint image, the memory size can be reduced to one for storing fingerprint data for 1.5 screens. Furthermore, if the size of a partial image is ¼ of a fingerprint image, the required memory size can be reduced to one for storing fingerprint data for 1.25 screens.

According to the first embodiment, the errors involved in the feature points extracted from partial images change with rotation. Hence, identity authentication can be carried out at an authentication accuracy appropriate for the degree of rotation if the tolerance is adjusted in response to the rotation given to the feature points extracted from partial images. For a small amount of rotation, the tolerance tends to be small, thus raising the accuracy of verification. For a large amount of rotation, on the other hand, the tolerance also tends to be large, thus lowering the probability of failing to identify a valid person (false nonmatch). Also, where an authentication line segment or reference line segment crosses a plurality of partial images, there are possibilities of increased errors because of different extraction accuracies for the feature points. In such a case, the increasing of tolerance accordingly will lower the probability of failing to identify a valid person.

Moreover, the displaying of the result of verification can have the user recognize the result of authentication. And even when a verification has ended in a failure, the user can be informed of the next processing to be operated. Also, the inputting of a fingerprint image as partial images can make the memory size necessary for processing smaller. And even when the memory size is made smaller, the accuracy of identification can be raised higher. Furthermore, both the false nonmatch rate and false match rate can be reduced.

According to the first embodiment, the input unit 10 inputs a plurality of partial images corresponding to a single fingerprint image. However, the arrangement is not limited thereto; it is not necessary that the plurality of partial images inputted by the input unit 10 be synthesized into a single fingerprint image. That is, the plurality of partial images may be equal to the images extracted discretely from a single fingerprint image. According to this modification, the number of partial images to be processed may be reduced, and the amount of processing and the memory capacity may be reduced, provided that the feature points are properly extracted.

### Second Embodiment

Of late years, authentication devices as described in the first embodiment are being built into more and more of mobiles devices, such as cellular phones. For such mobile devices, an authentication method capable of operating with smaller memory and lower-priced CPU needs to be incorporated unlike the case with desktop PCs or other large-scale systems.

Conventional fingerprint identification methods are roughly classified into (a) minutiae method, (b) pattern matching method, (c) chip matching method and (d) frequency analysis method. In (a) minutiae method, minutiae, which are ridge terminations, ridge bifurcations and other characteristic points of a fingerprint, are extracted from a fingerprint image, and information on these points are compared between two fingerprint images to verify the user's identity.

In (b) pattern matching method, image patterns are directly compared between two fingerprint images to verify the user's identity. In (c) chip matching method, a chip images, which are images of small areas around feature point, are enrolled as reference data, and verification of a fingerprint is done using these chip images. In (d) frequency analysis method, a frequency analysis is performed on a line slicing a fingerprint image, and a fingerprint is verified by comparing the distribution of the frequency components perpendicular to the slice direction between two fingerprint images.

Disclosed in Japanese Patent Application Laid-Open No. Hei 10-177650 is a technology for identity decision on two images, in which characteristic vectors are extracted from images of skin pattern or the like and similarity between two images is calculated using at least reliability information associated with the characteristic vectors as the characteristic quantities necessary for the verification.

There are disadvantages for each of these methods. Both (a) minutiae method and (c) chip matching method involve a larger amount of calculation because of their necessity for such preprocessing as connecting severed points in picked-up images. (b) pattern matching method, which relies on the storage of entire image data, needs large memory capacity especially when data on a large number of persons are to be enrolled. And (d) frequency analysis method, which requires frequency conversion, tends to have a large amount of computation. The technology disclosed by the above-mentioned literature, which is based on a statistical analysis, also involves a large amount of computation.

Hence, described in the following second to fourth embodiments of the present invention are verification methods and apparatuses that can carry out identity verification with smaller memory capacity and amount of computation.

In the second embodiment, a vector characterizing the directions of ridge or furrow lines in a linear region along a line perpendicular to a reference direction on a fingerprint image is obtained, and the component of such a vector is calculated. Then the distribution in the reference direction of the component is determined and compared with the similarly determined distribution of enrolled data to verify the match of the fingerprint images.

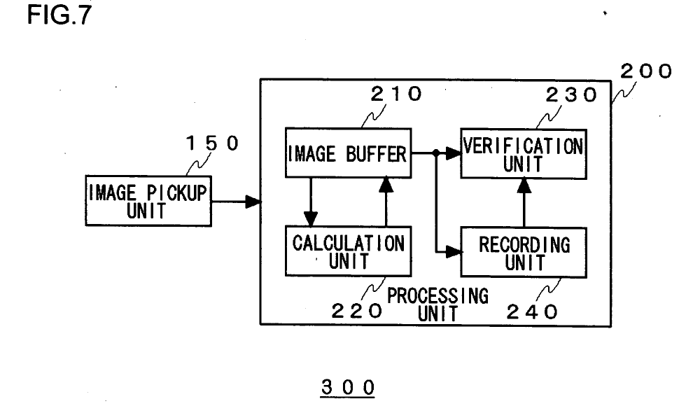

FIG. 7 is a function block of a verification apparatus 300 according to a second embodiment of the present invention. In terms of hardware, each block shown in FIG. 7 can be realized by various types of elements, such as a processor and RAM, and various types of devices, such as a sensor. In terms of software, it can be realized by computer programs or the like, but drawn and described herein are function blocks that are realized in cooperation with those. Thus, it is understood by those skilled in the art that these function blocks can be realized in a variety of forms such as by hardware only, software only or the combination thereof.

The verification apparatus 300 comprises an image pickup unit 150 and a processing unit 200. The image pickup unit 150, in which CCD (Charge Coupled Device) or the like is used, takes an image of a user's finger and outputs it to the processing unit 200 as image data. For instance, if the image is to be captured by a mobile device equipped with a line sensor such as CCD, a fingerprint image may be collected by requesting the user to hold his/her finger on a sensor and then sliding the finger in a perpendicular direction.

The processing unit 200 includes an image buffer 210, a calculation unit 220, a verification unit 230 and a recording unit 240. The image buffer 210 is a memory area which is used to store temporarily image data inputted from the image pickup unit 150 and which is also utilized as a working area for the calculation unit 220. The calculation unit 220 performs various types of computation (described later) on the image data in the image buffer 210. The verification unit 230 compares characteristic quantities of image data, to be authenticated, stored in the image buffer 210 with characteristic quantities of image data enrolled in the recording unit 240, and decides whether the fingerprint belongs to the same person or not. The recording unit 240 stores characteristic quantities of a fingerprint whose image has been taken in advance. Data on a single person are usually registered. However, if the verification apparatus 300 is used for a gate of a room or the like, data on a plurality of individuals will be enrolled instead.

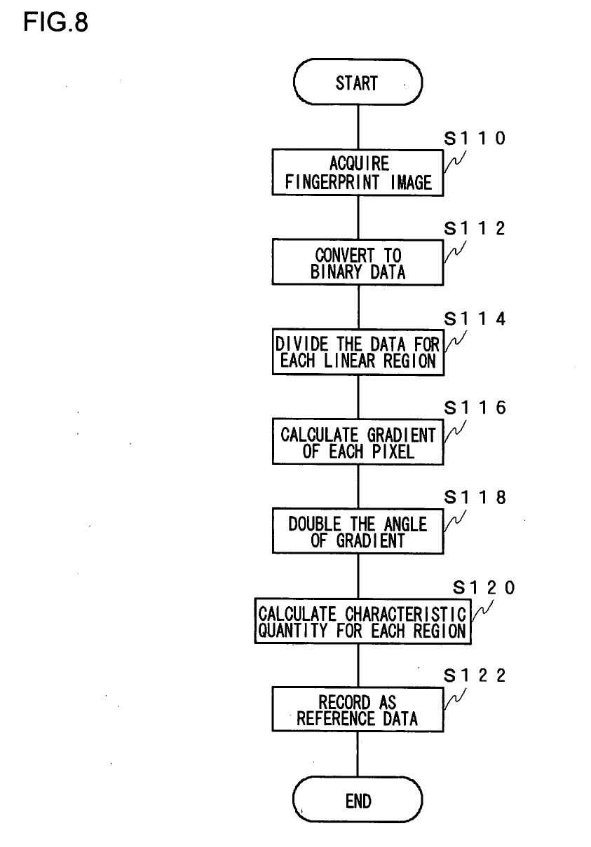

FIG. 8 is a flowchart showing a processing for generating the reference data in the verification apparatus 300 according to the second embodiment. The reference data are such that a fingerprint image of an individual to be authenticated is registered beforehand as a distribution of a predetermined directional component, namely, for example, the distribution of characteristic quantities that characterize the directions of ridge or furrow lines in the linear region.

First, the image pickup unit 150 takes an image of a finger held by a user, converts the captured image into electric signals and outputs them to the processing unit 200. The processing unit 200 acquires the electric signals as image data and stores them temporarily in the image buffer 210 (S110). The calculation unit 220 converts the image data into binary data (S112). For example, a decision is made in a manner such that a value which is brighter than a predetermined value is regarded white and a value which is darker than the predetermined value is regarded black. And the white is represented by “1” or “0” and the black is represented by “0” or “1”.

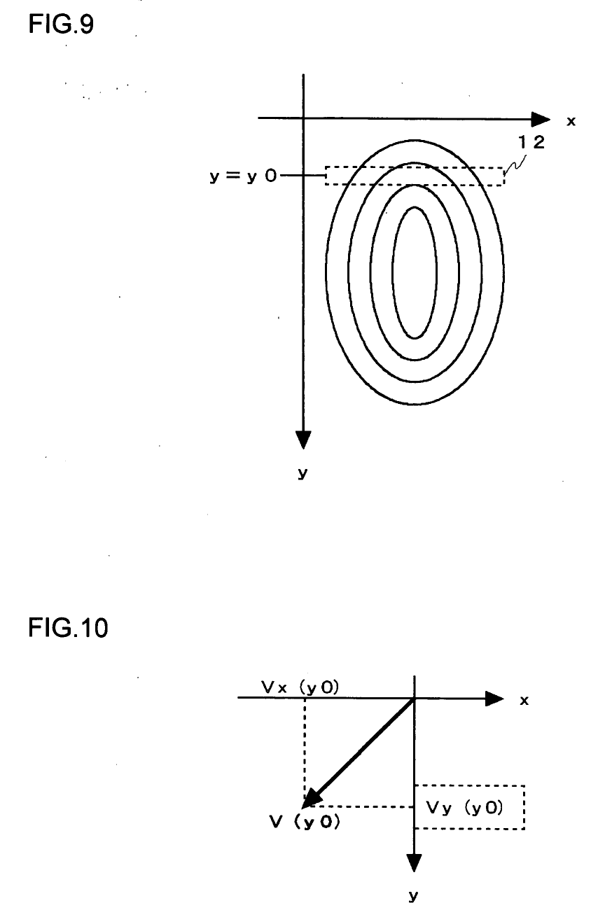

Then, the calculation unit 220 divides the binarized image data for each of linear regions (S114). FIG. 9 shows a fingerprint image captured in the second embodiment. In FIG. 9, the calculation unit 220 forms a linear region 112 having the longer sides in the X direction and the shorter sides in the Y direction. It is preferable that this linear region is such that the shorter side is set with one or three pixels. There are formed a plurality of linear regions in the Y direction, namely, in the longitudinal direction of a finger so as to divide the fingerprint image into a plurality of regions.

Then, the calculation unit 220 calculates the gradient of each pixel (S116). As a method for calculating the gradient, the method described in the literature “Tamura, Hideyuki, Ed., Computer Image Processing, pp. 182-191, Ohmsha, Ltd.” can be used.

Hereinbelow, the method will be briefly described. In order to calculate the gradients for digital images to be treated, it is necessary to calculate first-order partial differential equations in both the x direction and y direction.
Δₓf(i,j)≡{f(i+1,j)−f(i−1,j)}/2 (1)
Δ_{y}f(i,j)≡{f(i,j+1)−f(i,j−1)}/2 (2)

In a difference operator for digital images, the derivative values at a pixel (i, j) is defined by the linear combination of gray values of 3×3 neighboring images with the center at (i, j), namely, f(i±1,j±1). This means that the calculation to obtain derivatives of images can be realized by the spatial filtering using a 3×3 weighting matrix. And various types of difference operators can be represented by 3×3 weighting matrices. In the following (3), considered are 3×3 neighbors with the center at (i, j).
f(i−1,j−1)f(i,j+1)f(i+1,j−1)
f(i−1,j)f(i,j)f(i+1,j)
f(i−1,j+1) f(i,j+1)f(i+1,j+1) (3)
The difference operator can be described by a weighting matrix for the above (3).

For example, the first-order partial differential operators, in the x and y directions, defined in Equations (1) and (2) are expressed by following matrices (4).

$$( \begin{matrix}0 & 0 & 0 \\ - 1 / 2 & 0 & 1 / 2 \\ 0 & 0 & 0\end{matrix} ) and ( \begin{matrix}0 & - 1 / 2 & 0 \\ 0 & 0 & 0 \\ 0 & 1 / 2 & 0\end{matrix} ) \qquad ( 4 )$$

That is, in a rectangular area represented by (3) and (4) of 3×3, the pixel values are multiplied by matrix element values for the corresponding positions, respectively, and the summation thereof is calculated, which in turn will coincide with the right-hand sides of Equations (1) and (2).

The magnitude and the direction of a gradient are obtained as the following Equations (5) and (6), respectively, after the gradient is subjected to the spatial filtering by the weighting matrix of Equation (4) and calculating partial differentials defined in the Equations (1) and (2) in the x and y directions.
|∇f(i,j)|=\sqrt{Δₓf(i,j)²+Δ_{y}f(i,j)²} (5)
θ=tan⁻¹{Δₓf(i,j)/Δ_{y}f(i,j)} (6)

The Roberts operator, Brewitt operator, Sobel operator or the like is available as the above-mentioned difference operator. The gradients and so forth can be calculated in a simplified manner using such a difference operator and, anti-noise measures can also be taken.

Then the calculation unit 220 obtains a pair of values such that the direction obtained in Equation (6), namely, the angle of a gradient vector is doubled (S118). Although the direction of the ridge or furrow line of a fingerprint is calculated using the gradient vector in the present embodiment, the points whose ridge or furrow lines face in the same direction will not have the same gradient vector values. For this reason, the gradient vector is rotated so that an angle formed by the gradient vector and the coordinate axes becomes double, and then a single pair of values composed of an x component and a y component is obtained. Thereby, the ridge or furrow lines in the same direction can be represented by the unique pair of values having the same components. For example, 45° is the exactly opposite direction of 225° and vice versa. Now, if doubled, these doubled angles 90° and 450° will be the unique directions. Here, a pair of values composed of an x component and a y component is one in which a vector is rotated by a certain rule in a certain coordinate system. In this specification, such values will also be described as a vector.

Since the direction of ridge or furrow line in an area containing a fingerprint image varies widely at a localized area, an average will be taken within a certain range as will be described later. In that case, if the angle of a gradient is doubled so as to become the unique vector as described above, an approximate value of the direction of the ridge or furrow line can be obtained by taking the average after the thus doubled angles have been simply added together. Otherwise, the summation of two gradient vectors, which are opposite in direction they face, results in “0”, so that the simple addition does not render any meaningful result. In this case, a complicated calculation has to be done to compensate for the fact that 180° and 0° are equivalent to each other.

Then the calculation unit 220 adds up the vectors obtained for each pixel at each linear region so as to obtain an averaged vector. This averaged vector serves as a characteristic quantity (S120). This characteristic quantity is a value that indicates an average of the direction of the ridge or furrow line, and it is uniquely set for each region.

At this time, if white points alone or black points alone occur consecutively, a state continues in which the gradient cannot be defined. Thus, if this continues exceeding a predetermined number of points, such a portion may be excluded from the averaging processing. This predetermined number may be determined on an experimental basis.

Finally, the calculation unit 220 obtains the x component and the y component acquired for each region and records them as the reference data in the recording unit 240 (S122). The calculation unit 220 may record them after the distribution of x components and y components of said vector has been subjected to a smoothing processing as described later.

FIG. 10 illustrates a vector V(y0) that represents a feature in the linear region 112 of FIG. 9. The linear region 112 is a region cut out along y=y0 on the coordinate plane shown in FIG. 9. FIG. 10 shows a vector V=(Vx, Vy) that represents a feature of a ridge or furrow line in the area. Vx(y0) and Vy(y0) represent the end points intersecting with the x axis and y axis on the rectangular coordinates, respectively, with the starting point of the vector V(y0) as the origin. Used as a characteristic quantity is the value obtained after the angle of the gradient vector of each pixel as described above is doubled and then averaged.

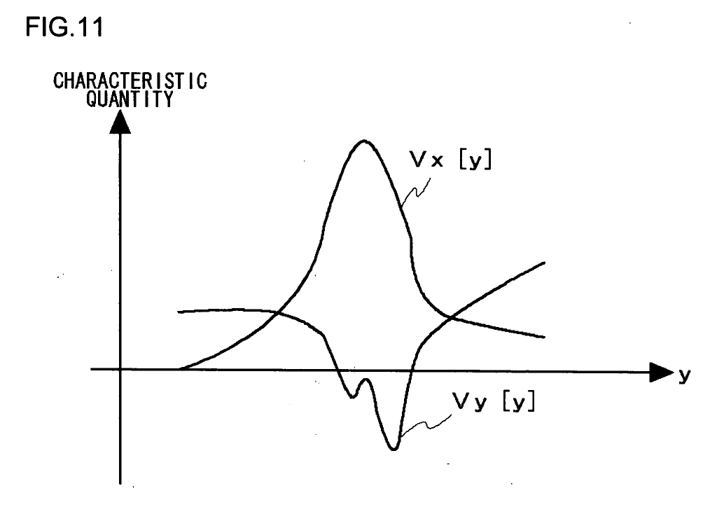

FIG. 11 shows a distribution of characteristic quantities obtained when the image of FIG. 9 is sliced for each linear region. That is, FIG. 11 shows the distribution of characteristic quantities acquired when the image is scanned in the y direction on the coordinate plane shown in FIG. 9, namely, in the direction vertical to the slicing direction of the linear region. The horizontal axis of FIG. 11 corresponds to the y axis of FIG. 9 whereas the vertical axis of FIG. 11 shows the characteristic quantity of each region. In FIG. 11, the vector characterizing each region is represented by an x component and a y component as shown in FIG. 10. The calculation unit 220 can obtain, from a fingerprint image to be enrolled, distribution of the x component and the y component of such a vector characterizing each region and store them as the reference data in the recording unit 240.

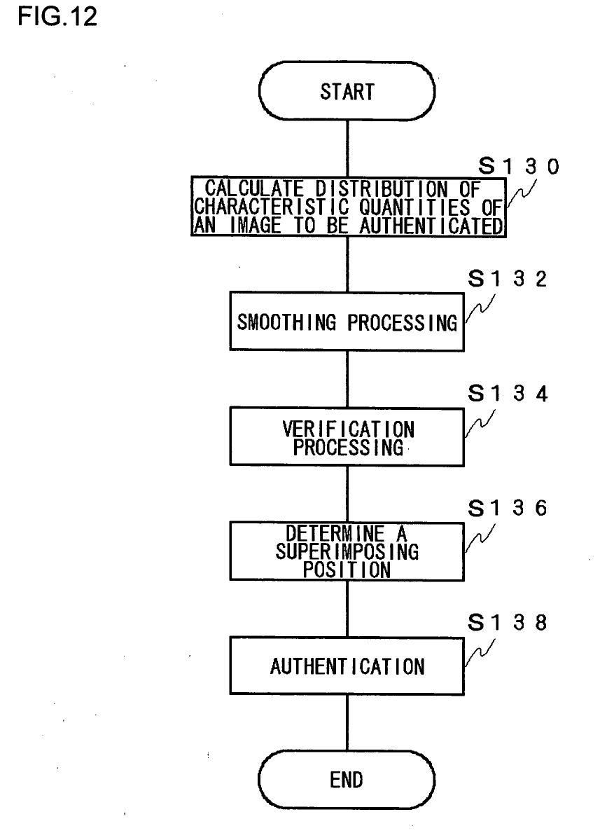

FIG. 12 is a flowchart showing an authentication processing of a verification apparatus 300 according to the second embodiment of the present invention. First, the image pickup unit 150 takes an image of a finger held by a user requesting a verification, converts the captured image into electric signals and outputs them to the processing unit 200. The processing unit 200 performs the same processings as Step S112 through Step S120 of FIG. 8 on the acquired image so as to calculate a distribution of characteristic quantities of image data which are the data to be authenticated (S130).

The calculation unit 220 has the distribution of characteristic quantities undergo a smoothing processing (S132). For example, some points in the vicinity of feature points or the like are averaged. The degree of smoothing to be done depends on an application to be used, and the optimum value therefor may be determined on an experimental basis.

Next, the verification unit 230 compares the distribution of characteristic quantities of reference data with that of data to be authenticated (S134). This verification processing is performed in a manner such that one of the distributions thereof is fixed and the other distribution thereof is slid gradually. And a pattern that matches most will be obtained. The entire pattern may undergo the pattern matching processing. However, in order to reduce the calculation amount, a processing may be such that feature points in the both distributions are detected and, with points that match therein being the centers, only some patterns surrounding the centers undergo the pattern matching processing. For example, a point at which the maximum value of x component occurs, a point bearing a value “0”, a point whose derivative is “0”, or a point whose slope or gradient is steepest may be used as a marked-out point.

The pattern matching can be carried out by detecting the difference between each component of the reference data and the data to be authenticated about each point on the y axis. For example, it can be done by calculating an energy E of the matching defined by the following Equation (7).
E=Σ\sqrt{ΔVx²+ΔVy²} (7)

The error ΔVx of x component and the error ΔVy of y component in the both distributions are each squared and added together and then the square root thereof is calculated. Since this x component and y component are primarily components of a vector, the error in magnitude of vector can be obtained. Such the errors are added in the direction of y axis, thus resulting as a matching energy E. Hence, the larger the energy E, the less approximated image it becomes whereas the smaller the energy E, the more approximated image it becomes. And the pattern whose matching energy E is minimum will be a superimposing position (S136). The pattern matching method is not limited thereto, and it may be, for example, such that the absolute value of the error ΔVx of x component and the absolute value of the error ΔVy of y component in the both distributions are added together. The method may also be such that a verification method exhibiting high accuracy is experimentally obtained and implement.

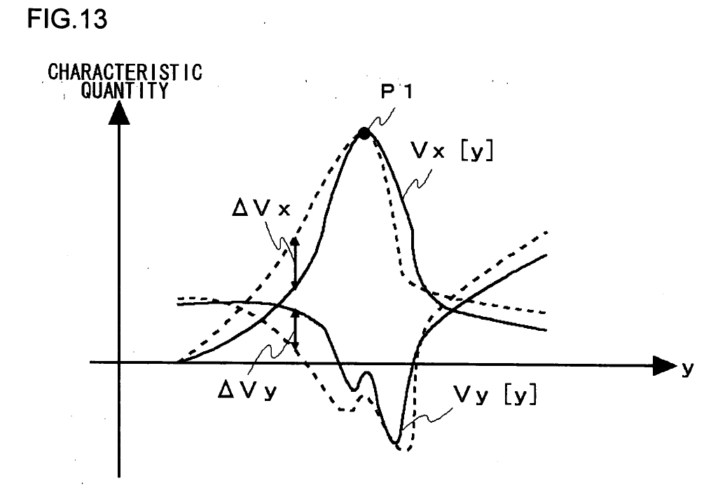

FIG. 13 shows how the distribution of characteristic quantities of reference data are superimposed on that of data to be authenticated in the second embodiment. In FIG. 13, the distribution of reference data is represented by the solid lines whereas that of data to authenticated is represented by dotted lines. In the example shown in FIG. 13, the maximum values of x components in the both distributions are first detected. Then the pattern matching is carried out in a first position where the maximum values p1 agree and in a second position where either of the distributions is shifted by a few points from the first position, and a position matched up most desirably is assumed as a superimposing position.

The verification apparatus 230 compares a calculated matching energy E with a predetermined threshold value with which to determine the success or failure of an authentication. And if the matching energy E is less than the threshold value, it is judged that the verification between the reference data and the data to be authenticated has been successful (S138). Conversely, if the matching energy E is greater than or equal to the threshold value, the authentication is denied. If a plurality of pieces of reference data are enrolled, the aforementioned processing will be carried out respectively between the plurality of pieces of reference data and the data to be authenticated.

As described above, according to the second embodiment, an image of biological information such as a fingerprint is divided into a plurality of predetermined regions, and a value that characterizes each region is used for a verification processing between the reference image and the image to be authenticated. As a result, the authentication processing can be carried out with a small amount of memory capacity. The calculation amount can also be reduced, thus making the authentication processing faster. Thus, applying the second embodiment to the authentication processing of mobile devices powered by batteries or the like gives rise to the reduced area of a circuit and the overall power saving. Since the characteristic quantity is obtained for each of the linear areas, the structure realized by the second embodiment is suitable for the verification of fingerprint images captured by a line sensor or the like. The characteristic quantities of each pixel are averaged for each region and the distribution of the average characteristic quantities undergoes the smoothing processing, thus realizing noise-tolerant verification apparatus and method. Since the averaging processing is executed in the linear region, whether a finger in question belongs to the same person or not can be verified even if the finger is slid from side to side. Differing from the minutiae method, the enrollment and authentication can be effectively and properly performed even if a fingerprint image containing strong noise is inputted.

### Third Embodiment

In the second embodiment, a method for dividing an image in one direction to obtain a linear region has been described. In a third embodiment of the present invention, a description will be given of an example of methods for dividing in a plurality of directions. For example, an image is sliced in two directions.

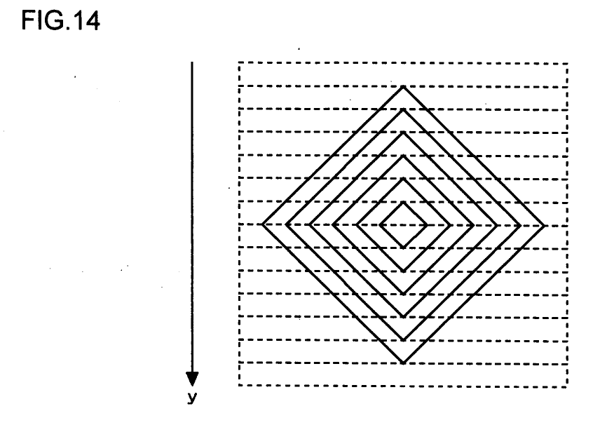

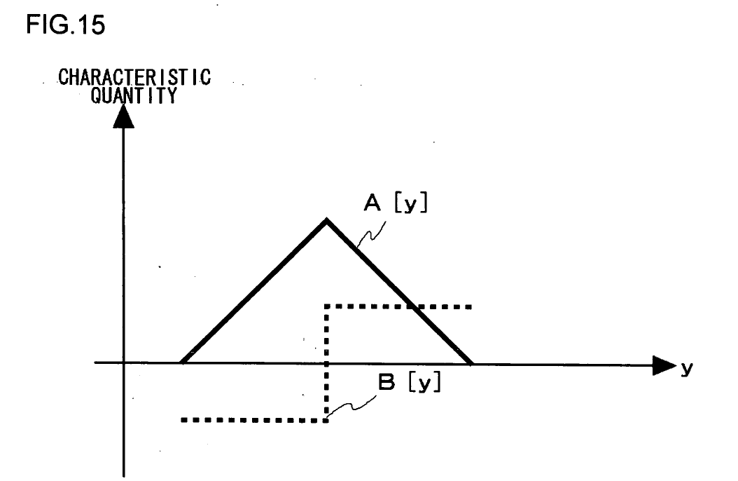

The structure and operation of a verification apparatus 300 according to the third embodiment are the same as those of the verification apparatus 300 according to the second embodiment shown in FIG. 7, and therefore the description thereof is omitted. FIG. 14 illustrates an example in which an image is sliced perpendicularly according to the third embodiment. It is to be noted here that an image to be verified may not only be a fingerprint image as described above but may also be an iris image or any other image representing biological information. For convenience of explanation, FIG. 14 shows an image with a striped pattern. FIG. 15 illustrates a distribution of characteristic quantities in their respective linear regions shown in FIG. 14. Shown is the distribution of characteristic quantities A and B, which characterize the respective linear regions, in their y direction, namely, the perpendicular direction.

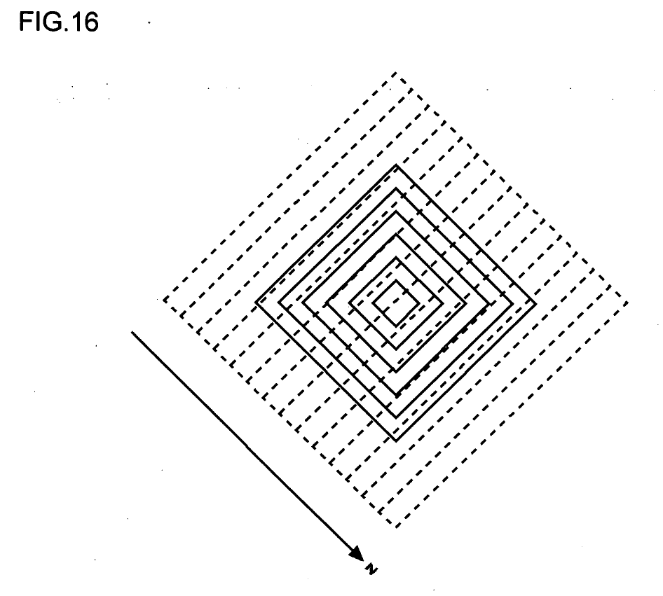

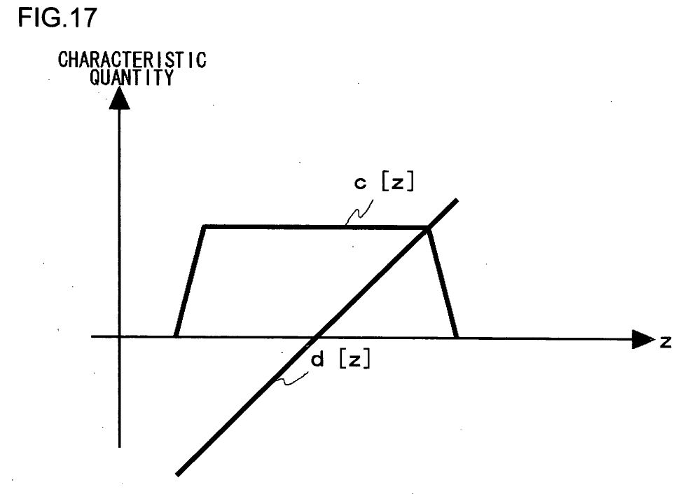

FIG. 16 illustrates an example of an image sliced in the direction of 45° according to the third embodiment. In FIG. 16, the same image as shown in FIG. 14 is sliced at an incline of 45 degrees. FIG. 17 illustrates a distribution of characteristic quantities in their respective linear regions shown in FIG. 16. Shown is the distribution of characteristic quantities C and D, which characterize the respective linear regions, in their z direction, or the 45-degree direction. In this manner, an image is sliced in two directions, and the characteristics of the image are represented by the four kinds of characteristic quantities A, B, C and D. The processing to generate reference data and the processing to authenticate inputted data according to the third embodiment may be carried out the same way as those of the second embodiment explained in FIG. 8 and FIG. 12, using these characteristic quantities. In this case, there are a plurality of matching energies E calculated from their respective directions, and therefore the verification unit 230 may, for instance, perform an identity verification by obtaining their average value.

It should be understood here that the characteristic quantities are not limited to the x component and y component of a vector which characterizes the ridges or furrows in a linear region as explained in the second embodiment. For example, they may be the gradation, luminance or color information of an image or other local image information or any numerical value, such as scalar quantity or vector quantity, differentiated or otherwise calculated from such image information.

According to the third embodiment, an image may be picked up by a one-dimensional sensor like a line sensor, taken in by an image buffer 210 and sliced in two or more directions, or a two-dimensional sensor may be used. The examples of two or more directions of slicing may generally include vertical, horizontal, 45-degree and 135-degree directions, but, without being limited thereto, they may be arbitrary directions. Moreover, the combination of two or more directions of slicing is not limited to vertical and 45-degree directions, but it may be set arbitrarily.

As described above, according to the third embodiment, a higher accuracy of verification than that according to the second embodiment can be achieved by the use of a plurality of directions for slicing an image to obtain linear regions. In the third embodiment, too, it is not necessary to generate an image from another image as in the minutiae method, so that this arrangement requires memory capacity only enough to store an original image. Hence, a highly accurate verification can be carried out with smaller memory capacity and smaller calculation amount.

### Fourth Embodiment

In the second and third embodiments, examples of verification methods using linear forms for sliced linear regions have been described. The form is not limited to linear, but it may be nonlinear such as curved, closed-curved, circular or concentric. In a fourth embodiment of the present invention, a description will be given of a method for verification of iris images as a representative example of dividing an image into nonlinear regions.

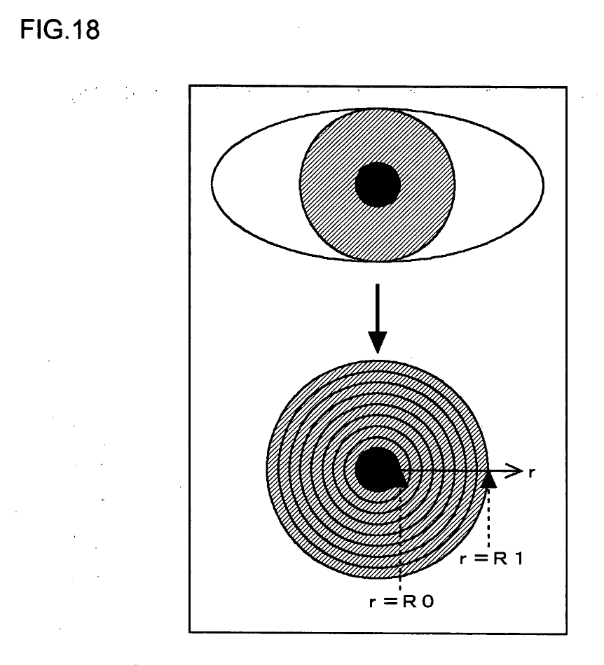

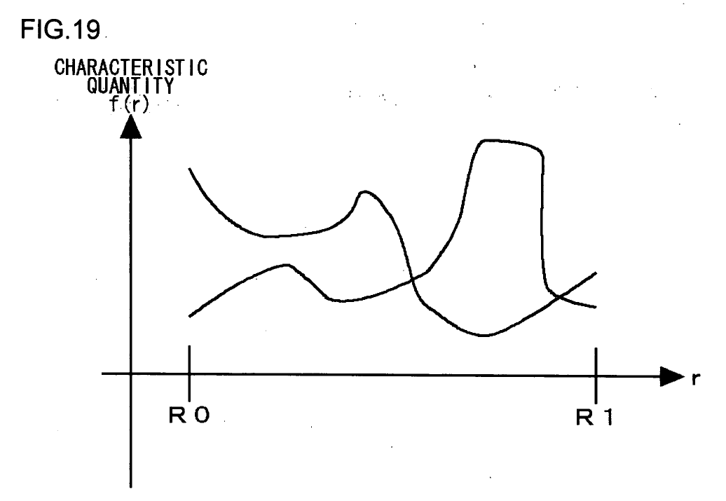

The structure and operation of a verification apparatus 300 according to the fourth embodiment are the same as those of the verification apparatus 300 according to the second embodiment shown in FIG. 7, and therefore the description thereof is omitted. FIG. 18 illustrates an example in which the iris part of an eye is divided into concentric areas according to the fourth embodiment. In FIG. 18, as the linear regions there are provided the concentrically divided areas. FIG. 19 illustrates a distribution of characteristic quantities in their respective concentric areas shown in FIG. 18. The distribution in the radial direction r of values characterizing the respective areas is derived. The processing to generate reference data and the processing to authenticate inputted data according to the fourth embodiment can be carried out the same way as those of the second embodiment explained in FIG. 8 and FIG. 12, using these characteristic quantities.

For the iris, the verification processing as explained in FIG. 12 is simpler. In the processing, the distributions of the two characteristic quantities are superimposed on each other between the authentication data and the reference data so that there are matches at the boundary R0 between pupil and iris and at the boundary R1 between iris and white of eye. Since the size of the pupil changes with the environmental brightness, it is necessary to change the distance between the boundary R0 and the boundary R1 of the authentication data to meet that of the reference data.

As described above, according to the fourth embodiment, verification of an iris image can be performed with smaller memory capacity and smaller amount of computation. Since characteristic quantities are obtained by averaging the gradient vectors or the like of the pixels in the concentric circular areas, verification can be carried out with high accuracy even when the eye position is rotated in relation to the reference data. This is comparable to the trait of fingerprint image identification in the second embodiment which can well withstand horizontal slides of a finger. Even when not all of the iris is picked up because it is partly covered with the eyelid, a relatively high level of accuracy can be achieved by performing a verification using a plurality of regions near the pupil.

It is to be noted that when a half of the iris is to be used for verification, the division may be made into half-circular areas instead of concentric areas. And the technique of dividing an image into nonlinear regions like this is not limited to the iris image, but may be applicable to the fingerprint image. For example, the center of the whorls of a fingerprint may be detected and from there the fingerprint may be divided into concentric circles outward.

The present invention has been described based on the embodiments which are only exemplary. It is understood by those skilled in the art that there exist still other various modifications to the combination of each component and process described above and that such modifications are within the scope of the present invention.

For such modifications, the authentication has been described in the above using a fingerprint or iris as an example of biological information. The present invention is also applicable to the authentication using palm print, face image, retina image and other various types of biological information. Some of such examples will be described hereinbelow.

For instance, the biometric authentication may be performed using an image of any arbitrary region, where the vein exists, such as a finger, palm or retina of an authenticatee, which is captured through the infrared photography technology. In this case, an image of vein shot in an infrared image is utilized in place of the ridge or furrow lines in the fingerprint image. An x component or y component of a vector that characterizes a vein image in each of regions into which an infrared image is divided is calculated, and the verification is carried out among infrared images using the data obtained from these components. The gradation, luminance or color information of an infrared image, other than the vein image, may also be used to acquire the characterizing vector.

Also, the biometric authentication may be performed using an image acquired by capturing the face image of an authenticatee from a specified direction. In this case, a well-known image processing technique may be first applied to the captured face image so as to calculate contour lines thereof. Then calculated is an x component and/or y component of a vector that characterizes the contour line in each of regions into which a face image is divided, instead of using the ridge or furrow lines in the fingerprint image. And the verification is carried out among the face images using the data obtained from these components.

Furthermore, the biometric authentication may be performed using an image acquired by capturing part (knee, for instance) of a body of an authenticatee from a specified direction. In this case, a well-known image processing technique may be first applied to the captured image of part of a body so as to calculate contour lines thereof. Then calculated is an x component and/or y component of a vector that characterizes the contour line in each of regions into which a body image is divided, instead of using the ridge or furrow lines in the fingerprint image. And the verification is carried out among the body images using the data obtained from these components.

When the biometric authentication is performed using the image of face or part of a body, the temperature distribution of a human body may be utilized instead of using the contour lines. For instance, the image of face or body of an authenticatee is picked up by thermography, and an image of the temperature distribution that represents the temperature distribution of face or body is obtained by analyzing the result of thermography. Then calculated is an x component and/or y component of a vector that characterizes a temperature boundary in each of regions into which a temperature-distribution image is divided. And the verification is carried out among the images of temperature distribution using the data obtained from these components. The gradation, luminance or color information of a temperature-distribution image, other than the temperature boundary, may also be used to acquire the characterizing vector.

In the above second to fourth embodiments, the vector calculated from a gradient vector of each pixel is used as a single physical quantity that characterizes the region for each of linear regions. The count of image gradation switching per linear area may be used as the single physical quantity. For example, an image is binarized so as to be a monochrome image, and the number of switches between black and white may be counted. The count value may be comprehended as the number of stripes of a fingerprint or the like. The density is high in a region where the stripes run vertical, so that the number of switches is large within a constant distance, namely, per unit length. This may be done in the x direction and the y direction. According to this modification, the verification can be carried out with simpler calculation and smaller memory capacity.

Though the binary data are used in the above second to fourth embodiments, the multiple-tone data may be used. In such a case, the method described in the literature “Tamura, Hideyuki, Ed., Computer Image Processing, pp. 182-191, Ohmsha, Ltd.” can be used, too, and the gradient vector of each pixel can be calculated. According to this modification, highly accurate verification can be achieved while the calculation amount is increased compared with the case of monochrome images used.

When the above described verification processing is performed, any linear region that does not contain the stripe pattern may be skipped. For example, in such cases when the vector of more than a preset value cannot be detected for the length of a line, when the white continues for more than a preset value, when the region is determined to be almost blacked out since the black continues for more than a preset value, when the count of switches between black and white is below a preset value, the processing is carried out excluding such a region depicted above. According to this modification, the calculation amount in the verification processing can be reduced.

Although the present invention has been described by way of exemplary embodiments and modifications, it should be understood that many other changes and substitutions may further be made by those skilled in the art without departing from the scope of the present invention which is defined by the appended claims.

What is claimed is:

1. An authentication apparatus, comprising:
an input unit which inputs a plurality of pieces of partial information corresponding to parts of biological information on an authenticatee;
an extraction unit which extracts feature points of the biological information respectively from the plurality of pieces of partial information inputted to said input unit;
a generation unit which synthesizes the feature points extracted respectively from the plurality of pieces of partial information and which generates feature point information for authentication;
an acquisition unit which acquires reference feature point information to be compared with the authentication feature point information generated by said generation unit;
a rotation unit which performs phase rotation on the generated authentication feature point information so that a phase component contained in the generated authentication feature point information approaches that contained in the acquired reference feature point information; and
an authentication unit which authenticates the authentication feature point information to which the phase rotation has been performed by said rotation unit, based on the acquired reference feature point information,
wherein said authentication unit adjusts tolerance for authentication in accordance with a degree of phase rotation performed by said rotation unit.

2. An authentication apparatus according to claim 1, wherein if the degree of rotation performed by said rotation unit increases, said authentication unit increases the tolerance.

3. An authentication apparatus according to claim 1, wherein said authentication unit performs authentication by comparing an error between a line segment between the feature points obtained from the authentication feature point information to which the phase rotation has been performed and a line segment between the feature points obtained from the acquired reference feature point information with the tolerance, and increases the tolerance if the line segment between the feature points obtained from the authentication feature point information to which the phase rotation has been performed crosses a plurality of pieces of partial information.

4. An authentication apparatus according to claim 2, wherein said authentication unit performs authentication by comparing an error between a line segment between the feature points obtained from the authentication feature point information to which the phase rotation has been performed and that between the feature points obtained from the acquired reference feature point information with the tolerance, and increases the tolerance if the line segment between the feature points obtained from the authentication feature point information to which the phase rotation has been performed crosses a plurality of pieces of partial information.

5. An authentication apparatus according to claim 3, wherein the reference feature point information acquired by said acquisition unit is generated from a plurality of pieces of partial information in a similar manner to the authentication feature point information, and
wherein at the time of authentication said authentication unit increases the tolerance if the line segment between the feature points obtained from the acquired reference feature point information crosses a plurality of pieces of partial information.

6. An authentication apparatus, comprising:
an input unit which inputs a plurality of pieces of partial information corresponding to parts of biological information on an authenticatee; and
a display unit which generates feature point information for authentication by synthesizing feature points after the feature points have been extracted respectively from the inputted plurality of pieces of partial information,
performs phase rotation on the generated authentication feature point information so that a phase component contained in the generated authentication feature point information approaches that contained in reference feature point information for comparison, and
displays a result of authenticating the authentication feature point information to which the phase rotation has been performed, based on the reference feature point information based on tolerance adjusted in accordance with an amount of the phase rotation and the reference feature point information.

7. A verification method, comprising:
dividing a reference image for verification into predetermined regions;
calculating a predetermined directional component as a characteristic quantity for each of the regions; and
recording the directional component.

8. A verification method according to claim 7, further comprising:
dividing an image to be verified into predetermined regions;
calculating a predetermined directional component as a characteristic quantity for each of the regions; and
verifying the calculated directional component with the directional component of the reference image.

9. A verification method, comprising:
dividing a reference image for verification into predetermined regions;
calculating a single physical quantity as a characteristic quantity for each of the regions; and
recording the single physical quantity.

10. A verification method according to claim 9, further comprising:
dividing an image to be verified into predetermined regions;
calculating a single physical quantity as a characteristic quantity for each of the regions; and
verifying the calculated single physical quantity with the single physical quantity of the reference image.

11. A verification method according to claim 7, wherein said calculating undergoes an averaging process for each of the regions.

12. A verification method according to claim 8, wherein said calculating undergoes an averaging process for each of the regions.

13. A verification method according to claim 9, wherein said calculating undergoes an averaging process for each of the regions.

14. A verification method according to claim 10, wherein said calculating undergoes an averaging process for each of the regions.

15. A verification method, comprising:
slicing a reference image for verification so as to be divided into linear regions;
calculating a count of image density switching as a characteristic quantity for each of the linear regions; and
recording the count of image density switching.

16. A verification method according to claim 15, further comprising:
slicing an image to be verified so as to be divided into linear regions;
counting the number of image density switchings as a characteristic quantity for each of the linear regions; and
verifying the counted number of image density switchings with the count of image density switching in the reference image.

17. A verification apparatus, comprising:
an image pickup unit which captures an image to be verified;
a calculation unit which divides the captured verification image into predetermined regions and calculates a predetermined directional component as a characteristic quantity for each of the regions; and
a verification unit which verifies the directional component of the verification image with a directional component of a reference image.

18. A verification apparatus, comprising:
an image pickup unit which captures an image to be verified;
a calculation unit which divides the captured verification image into predetermined regions and calculates a single physical quantity as a characteristic quantity for each of the regions; and
a verification unit which verifies the single physical quantity of the verification image with a single physical quantity of a reference image.

19. A verification apparatus according to claim 17, wherein said calculation unit carries out an averaging process for each of the regions.

20. A verification apparatus according to claim 18, wherein said calculation unit carries out an averaging process for each of the regions.
